(19) United States
(12) Patent Application Publication
(10) Pub. No.: US 2018/0074180 A1
(43) Pub. Date: Mar. 15, 2018

(54) ULTRAFAST TARGET DETECTION BASED ON MICROWAVE METAMATERIALS

(71) Applicant: Wayne State University, Detroit, MI (US)

(72) Inventor: Michael Chung-Tse Wu, Royal Oak, MI (US)

(21) Appl. No.: 15/553,921

(22) PCT Filed: Feb. 26, 2016
(86) PCT No.: PCT/IB2016/051074

§ 371 Date: Aug. 25, 2017

Related U.S. Application Data
(60) Provisional application No. 62/126,005, filed on Feb. 27, 2015.

(51) Int. Cl. G01S 13/06; H04B 1/38; G01S 3/04; G01S 13/04

(52) U.S. Cl. CPC G01S 13/06; G01S 13/04; G01S 3/04; H04B 1/38

(57) ABSTRACT

A system (100) for locating an object (114) includes a signal source (102) that generates a wideband signal (104) that includes a continuously variable frequency from a first frequency to a second frequency, a microwave metamaterial leaky wave antenna (106) that receives the wideband signal as an input and maps the wideband signal from the first frequency to the second frequency as electromagnetic radiation that increases as a function of an azimuthal direction (108,110,112), the microwave metamaterial leaky wave antenna (106) positionable to face toward an object that is within its field-of-view FOV, wherein the transceiver assembly is positioned to receive the electromagnetic radiation that is reflected from the object and convert the reflected electromagnetic radiation to a reflected electrical signal, and an analyzer (118) configured to identify a main beam frequency of the reflected electrical signal and determine an azimuthal angle (108,110,112) and distance to the object based on the main beam frequency.

### CROSS-REFERENCE TO RELATED APPLICATIONS

This application claims priority to International Patent Application No. PCT/IB2016/051074 filed on Feb. 26, 2016, which claims priority to U.S. Provisional Application Ser. No. 62/126,005 filed on Feb. 27, 2015, the contents of which are incorporated by reference in their entirety.

### TECHNICAL FIELD

This disclosure relates generally to an object detecting system, and more specifically to an apparatus and method of providing driving assistance in a vehicle to detect azimuthal locations of objects over a wide angle and range.

### BACKGROUND

There has been a need for detecting the location of objects in real time with a large field-of-view (FOV), especially in military and defense applications. Recently, as the market for automotive radars has increased worldwide, high performance and low cost short and mid-range radars that can help drivers to prevent car accidents are also in demand. Automotive radars can function well under severe weather situations compared with other sensing technologies such as Lidar, ultrasound sonar or camera videos. Lidar, for instance, is a surveying technology that measures distance by illuminating a target with a laser light. Ultrasound sonar uses sound waves having frequencies that are higher than the upper audible limit of human hearing. And camera videos, of course, rely on visual images for object detection. Such systems, although well-known and in use extensively, have certain drawbacks that may include extensive post-processing of data, weather sensitivity, high system cost, and limits in the ability to detect distances.

Automotive radars overcome several of the drawbacks and can provide object detection in a variety of operating conditions. However, in conventional radar systems, either phased arrays or mechanical beam scanning antennas are utilized to perform target searching. These systems usually have complex architectures and can be very costly. Moreover, a large amount of post-processing may be required to obtain the desired information, which can limit the latency performance of the system.

Some known systems of detection include a leaky-wave antenna (LWA). A LWA belongs to a general class of travelling wave antenna that uses a traveling wave on a guiding structure as the main radiating mechanism. One system incorporates a microstrip leaky wave antenna (MLWA) that can be used to achieve human tracking using its frequency-scanned beam. A frequency-scanned beam of the MLWA and its frequency bandwidth are exploited to achieve simultaneous bearing estimation and ranging within a single frequency sweep, which can be used as a radar front end to achieve range and azimuth tracking of objects such as humans. Thus, 2D range-azimuth images can be generated. However, the antenna needs to be placed tilted as the MLWA can only scan a limited angle in the forward direction.

Thus, there is a need to improve object detection systems.

### SUMMARY

The disclosure is directed toward a method and apparatus of providing driving assistance in a vehicle to detect azimuthal locations of objects over a wide angle and range.

According to one aspect, a system for locating an object includes a signal source that generates a wideband signal that includes a continuously variable frequency from a first frequency to a second frequency, a microwave metamaterial leaky wave antenna that receives the wideband signal as an input and maps the wideband signal from the first frequency to the second frequency as electromagnetic radiation that increases as a function of an azimuthal direction, the microwave metamaterial leaky wave antenna positionable to face toward an object that is within its field-of-view (FOV), wherein the transceiver assembly is positioned to receive the electromagnetic radiation that is reflected from the object and convert the reflected electromagnetic radiation to a reflected electrical signal, and an analyzer configured to identify a main beam frequency of the reflected electrical signal and determine an azimuthal angle to the object based on the main beam frequency.

According to another aspect, a method for detecting a location of an object includes emitting electromagnetic radiation from a microwave metamaterial leaky wave antenna over a field-of-view (FOV), such that its frequency continuously increases over the FOV as a function of an azimuthal direction, receiving the electromagnetic radiation that is reflected from an object that is positioned within the FOV, identifying a main beam frequency within the reflected radiation, and determining an azimuthal angle to the object based on the main beam frequency.

According to yet another aspect, a transceiver assembly for locating an object includes a microwave metamaterial leaky wave antenna that receives a wideband signal from a source and as an input, the microwave metamaterial leaky wave antenna maps the wideband signal from a first frequency to a second frequency as electromagnetic radiation that increases as a function of an azimuthal direction, the microwave metamaterial leaky wave antenna positionable toward an object that is within its field-of-view (FOV), wherein the transceiver assembly is positioned to receive reflected electromagnetic radiation from the object, and an analyzer configured to identify a main beam frequency of the reflected electromagnetic radiation and determine an azimuthal angle to the object based on the main beam frequency.

Various other features and advantages will be made apparent from the following detailed description and the drawings.

### BRIEF DESCRIPTION OF THE DRAWINGS

FIG. 1 is a system or transceiver assembly includes an emitter and receiver that determine an azimuthal angle to an object.

FIG. 2 illustrates an exemplary continuously variable frequency generated as a signal.

FIG. 3 illustrates an exemplary correlation between an azimuthal angle θ and a frequency.

FIG. 4 illustrates an exemplary reflected signal and a portion of the correlation of FIG. 3.

FIG. 5 illustrates an exemplary wideband signal that is output as a pulse signal having a series of pulses.

FIG. 6 illustrates one example of a system in which a vector network analyzer (VNA) is used to generate a linearly chirped signal.

FIG. 7 shows a dispersion diagram of LWA in which β is the propagation constant and p is the unit cell periodicity.

### DETAILED DESCRIPTION

The operating environment of disclosure is described with respect to use in an automotive vehicle for object detection. However, it is contemplated that the disclosure may be applicable for other environments and applications, such as object detection in sea-going vessels or airborne vehicles. In fact, the disclosure is applicable to any system that may benefit from a system in which an object location may be identified.

The disclosure is an ultrafast target detecting system radar application, such as for automotive applications, that can provide driving assistance by detecting the azimuth locations of a wide angle or field-of-view (FOV) over −90° to +90°, defined generally as a half-space. The disclosed method and apparatus provide the ranges and azimuthal locations of multiple objects in real time using microwave metamaterials (MTMs).

An ultrafast microwave metamaterial-based target detecting system that can detect azimuth locations of objects is disclosed. The disclosed method and apparatus relies on space-to-frequency mapping characteristics of microwave metamaterial leaky wave antennas. By mapping locations to frequencies, the disclosed object detecting method and apparatus use minimal signal post-processing, if any, and any post-processing performed is commonly carried out in conventional imaging or radar systems and is thus not computationally burdensome. The data acquiring speed is dominated by the frequency sweeping speed of signal source, which is typically on the order of a few milliseconds, thereby achieving real time location detection. This speed can be further boosted to microseconds and even nanoseconds range by using a pulse generator as the signal source. Moreover, the disclosed scheme dramatically reduces the system complexity compared to phased arrays or mechanical beam scanning arrays, and therefore is applicable for use in real time automotive radar systems.

The disclosed method and apparatus employs the use of MTMs. Since about 2002, microwave MTMs have been used as forms of transmission line structures or so-called composite right/left-handed transmission lines (CRLH TLs), and they can also be used as leaky wave antennas (LWAs). CRLH LWAs have a unique characteristic that can map different frequency components into different directions of an entire half-space continuously from a backfire-to-endfire side of the antenna, which is not available in conventional MLWAs.

Using the frequency-space mapping characteristics of CRLH LWAs, disclosed is an ultrafast target detecting scheme that can detect the location of an object in real time. This results from the fact that the disclosed scheme uses, at most, only a minimum post-processing algorithm to determine the location. Because the CRLH LWA launches waves with different frequencies to different directions, location detection is performed by simply sweeping the frequency and detecting the dominant frequency component of the reflected signal. Therefore, the data acquisition time is dominated by the sweeping speed of the signal source, typically of order of milliseconds, which enables real time object detection. It is contemplated that, although the exemplary illustrations provided in the disclosure are directed toward azimuthal angle determination to an object, implementations of the disclosure also include a time-of-flight calculation that may also provide object distance calculations based on the known speed of propagation of electromagnetic signals that occur at the speed of light. That is, the range information can be obtained using the well-known equation:

$$range = c \times \frac{{τ}_{g}}{2} ; , \qquad Eqn . 1$$

where c is the speed of light and τ_{g} is the group delay response.

Also and as stated, instead of sweeping the frequency a short pulse modulated to the center frequency of the antenna can be used to launch every frequency component in the antenna bandwidth all at once. In this way, the scanning speed will depend on the pulse repetition rate, which typically ranges from 1 MHz-1 GHz, or equivalently 1 μs-1 ns per scan. In addition, the disclosed detecting scheme using CRLH LWAs is fully integrable with planar circuitries and therefore may be installed in automotive radars.

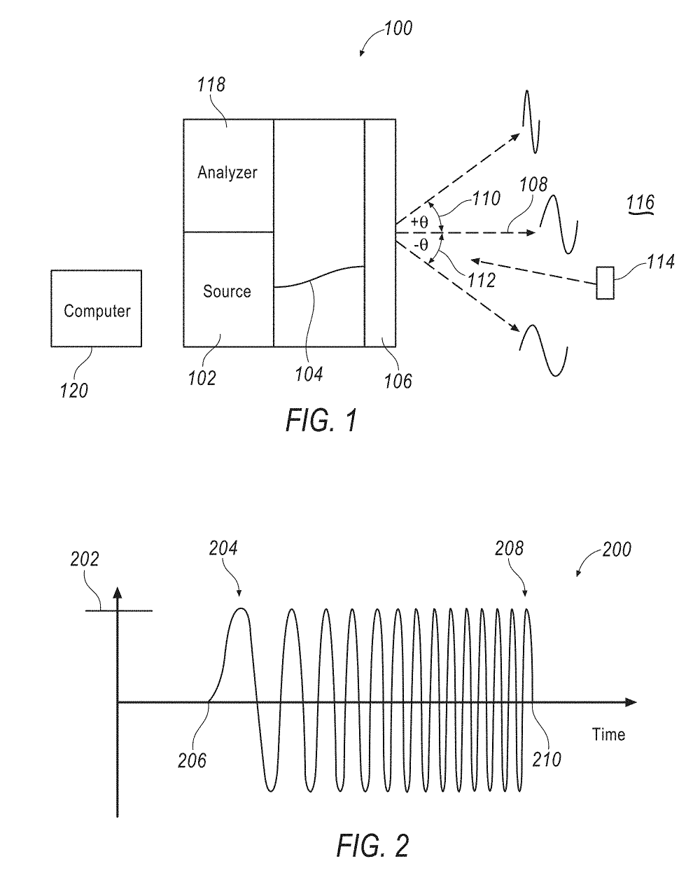

Referring to FIG. 1, a system or transceiver assembly 100 includes a signal source 102 that generates a wideband signal 104 that includes a continuously variable frequency from a first frequency to a second frequency. An exemplary continuously variable frequency 200 generated as signal 104 is illustrated in FIG. 2. Referring to FIG. 2, a variable frequency signal 200 is illustrated in which signal 200 has an amplitude 202 and is generated from a first frequency 204 at a first time 206, and the frequency of signal 200 is varied over time until a second frequency 208 occurs at a second time 210. More specifically, signal 200 is a wideband signal that starts at first frequency 204 and increases continuously and over time until second frequency 208 occurs. The wideband signal, as is known within the art, refers to a signal that covers the operating band of metamaterial leaky wave antennas. In one example signal 200 is varied from approximately 8.7 GHz to approximately 13.9 GHz. However, it is contemplated that signal 200 may include other frequencies and ranges of frequencies that vary from a first frequency to a second frequency. In the example above, signal 200 is in the GHz range, but it is contemplated that signals having a lower frequency and in the MHz may be used, as well as signals having a higher frequency such as in the range of 100 GHz and beyond, depending on the operating band of metamaterial leaky wave antennas.

Referring back to FIG. 1, system 100 includes a microwave metamaterial leaky wave antenna 106 that receives the wideband signal 104 as an input and maps the wideband signal from the first frequency to the second frequency as electromagnetic radiation that increases as a function of an azimuthal direction. An angle toward the front of microwave metamaterial leaky wave antenna 106 is defined, in one example, as 0° orientation 108. A positive θ “+0” angular direction is defined 110 to one angular side of 0° orientation 108, and a negative θ “−0” angular direction is defined 112 to the other angular side of 0° orientation 108. Positive θ 110 varies from 0° at orientation 108 to +90°, and negative θ 112 varies from 0° at orientation 108 to −90°. Thus, a field-of-view (FOV) is defined over a 180° range and from −90° to +90°.

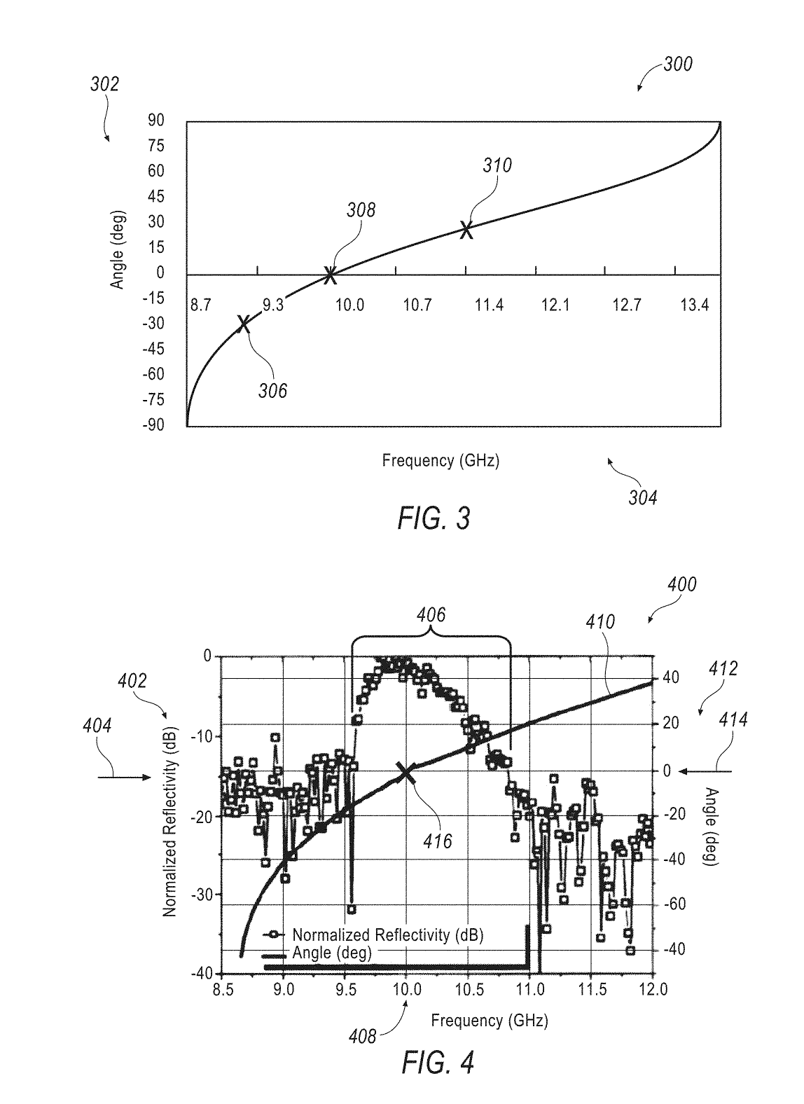

According to the above example and referring to FIGS. 1-3, wideband signal 104 of system 100, having the exemplary characteristics of signal 200, varies from first frequency 204 to second frequency 208. Microwave metamaterial leaky wave antenna 106 maps signal 200 from approximately 8.7 GHz to approximately 13.9 GHz over an azimuthal direction from −90° to +90°. A correlation 300 between azimuthal angle θ 302 and frequency 304 is illustrated in FIG. 3. Correlation 300 illustrates, as one example, at a first point 306 that approximately 9.1 GHz corresponds with approximately −30°. Another example includes a second point 308 in which approximately 10.0 GHz corresponds with approximately 0°, and another example in which a third point 310 correlates approximately 11.4 GHz with approximately 25°. Of course the more specific correlation between the frequency and angular or azimuthal orientation are well known and mapped with a high degree of accuracy, but they are discussed herein for exemplary purposes to illustrate and understand the disclosed subject matter.

Referring again to FIG. 1, system 100 having microwave metamaterial leaky wave antenna 106 is positionable toward an object 114 that is within its field-of-view (FOV) 116. FOV 116 is defined therefore over the azimuthal range of −90° to +90°. In being positionable, it is contemplated that system 100 may be positioned on a mobile vehicle or vessel such as an automobile, truck, ship, or aircraft, as examples. In another example, system 100 may be positioned or positionable on a fixed object such as a wall or tower.

In operation, microwave metamaterial leaky wave antenna 106 thereby maps wideband signal 104 such that electromagnetic radiation is emitted therefrom over the angular or azimuthal range from −90° to +90° and according to a known correlation with frequencies, such as is illustrated in FIG. 3. Object 114, positioned within the FOV 116 of system 100 and particularly microwave metamaterial leaky wave antenna 106, reflects the electromagnetic radiation which has been received having a frequency that corresponds with correlation 300. As such, object 114 reflects the electromagnetic radiation having a frequency that also corresponds with correlation 300. As such, system 100 of FIG. 1 includes an analyzer 118 that is configured to identify a main beam frequency of the reflected electrical signal and determine an azimuthal angle to the object based on the main beam frequency.

As one example, an exemplary reflected signal 400 is shown in FIG. 4, in which the reflected signal is normalized in units of dB 402. The reflected signal 400 includes a “noise floor” 404 of approximately −15 to −20 dB or lower. The reflected signal also, however, includes a reflected component having an elevated normalized reflectivity 406. As seen therein, elevated normalized reflectivity 406 represents a reflected signal that spans approximately from 9.6 GHz to 10.7 GHz. Thus, in this example a main beam frequency spans approximately 9.6 GHz to 10.7 GHz and may be used to analyze and determine an azimuthal angle to an object that reflects the signal, such as object 114 of FIG. 1. In one example, a maximum 408 of the main beam frequency 406 may be identified by analyzer 118, and correlation 300 may thereby be used to relate the reflected signal to the azimuthal angle. FIG. 4 includes a portion 410 of correlation 300 that relates the frequency to azimuthal angle 412. As shown therein, maximum 408 occurs at approximately 10.0 GHz, which translates via portion 410 to approximately 0° 414, identified also as point 416. It is noted, also, that point 416 corresponds with point 308 of FIG. 3. It is also contemplated that, although maximum 408 of main beam frequency 406 is used to identify the angle to the object, other methods may be used to determine which frequency from elevated normalized reflectivity 406 may be used to identify the azimuthal angle. For instance, in one example an average between the low and high frequencies may be used (such as the average of 9.6 GHz and 10.7 GHz), and in another example a curve-fit routine may be used to fit the data that makes up main beam frequency 406, and the maximum may be extracted numerically from the curve fit. It is noted, however, that minimal or no post-processing of data may be desired, in which case it may be preferred to simply obtain the maximum datapoint that occurs within main beam frequency 406, and determine the azimuthal angle therefrom and using portion 410 of correlation 300. It is further contemplated that the “noise floor”, normalized reflected signal, and the like, are merely exemplary and that such values will vary from system to system.

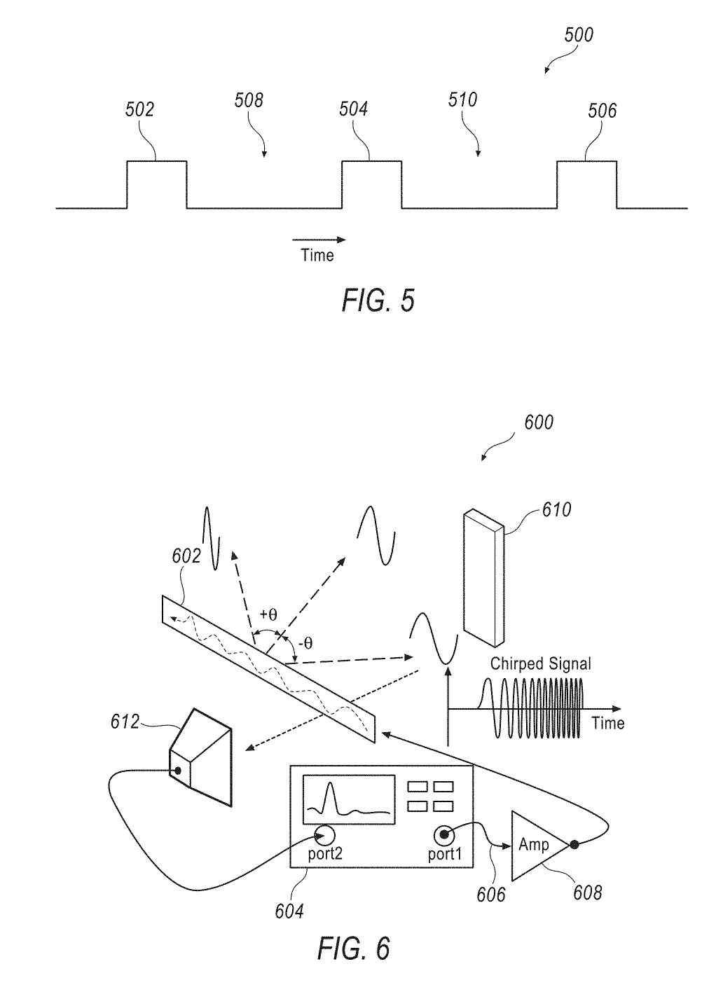

As such, the FOV 116 extends as a full FOV from −90 degrees to +90 degrees and the microwave metamaterial leaky wave antenna 106 maps the wideband signal 104 over the full FOV 116. In one example, referring now to FIG. 5, wideband signal 104 is output as a pulse signal 500 as a series of pulses 502, 504, 506, etc. . . . Each pulse 502-506 includes a full spectrum of frequencies ranging from a first frequency to a second frequency, such as frequencies 206, 210 of FIG. 2. In such fashion, gaps 508, 510, etc. . . . in time that occur respectively between pulses 502-506 may be exploited as time during which emitted electromagnetic radiation may be emitted to the object 114, and reflected back to system 100. It is known that a microwave metamaterial leaky wave antenna may serve not only as an emitter of electromagnetic radiation as discussed above, but also that a microwave metamaterial leaky wave antenna may also serve to detect electromagnetic radiation as well. As such, in the example of FIG. 5, pulse signal 500 is emitted toward object 114 and, during the gaps in time 508, 510 between pulses 502-506, the reflected electromagnetic radiation is detected by microwave metamaterial leaky wave antenna 106. Thus, instead of sweeping the frequency a short pulse modulated to the center frequency of the antenna can be used to launch every frequency component in the antenna bandwidth all at once. In this example, analyzer 118 is coupled to the microwave metamaterial leaky wave antenna 106. Also, although only one object 114 is illustrated, it is contemplated that more than one object may also be detected, each having a frequency reflected that corresponds with its azimuthal angle.

In another example, however, wideband signal 104 is output as a linearly chirped signal that sweeps from the first frequency to the second frequency. Referring now to FIG. 6, a system 600 is shown having components that are separated from one another. In this example, microwave metamaterial leaky wave antenna 602 is coupled to a network analyzer 604 that includes an output 606 that passes through an amplifier 608. As discussed above, a continuous range of frequencies is generated, in this case in network analyzer 604, and microwave metamaterial leaky wave antenna 602 outputs the signal as a chirped signal that scans from the first or low frequency continuously to the second or high frequency. In this example, however, the microwave metamaterial leaky wave antenna 602 is used essentially continuously for signal generation to an object 610. As such, system 600 further includes a separate antenna 612 positioned proximate the microwave metamaterial leaky wave antenna 612 that receives the reflected electromagnetic radiation from object 610. In one example, antenna 612 is a horn antenna that, as commonly known in the art, is an antenna that includes a flaring metal waveguide shaped like a horn to direct radio waves in a beam. In another example, the microwave metamaterial leaky wave antenna is a composite right/left-handed transmission line (CRLH TL).

Thus, FIG. 6 illustrates one example of a setup or system in which a vector network analyzer (VNA), such as network analyzer 604, is used to generate a linearly chirped signal that goes into the input of microwave metamaterial leaky wave antenna 602. According to the dispersion of composite right/left hand (CRLH) unit-cell as shown in FIG. 3, the lower frequency components will be mapped to the backward direction of the antenna (−90°<θ<0°), whereas the higher frequency components will be mapped to the forward direction (0°<θ<90°). If the wave or emitted electromagnetic radiation hits an object, such as object 114 in FIG. 1, it will be scattered back and received by broadband horn antenna 612 that has its output connected to a port of VNA 604. In this particular set-up, by measuring S21 of S-parameters on VNA 604, the reflectivity from the metallic slab is effectively being read at different frequencies. Therefore, depending on the azimuthal location of object, a strong reflectivity will be seen at the frequency corresponding to its azimuthal location.

It is noted that because of the disclosed scheme, the data acquiring speed is mostly dominated by the sweeping speed of the signal source when using a chirped signal, which in one example is 50 ms for a single sweep. As stated, however, the speed can be further boosted up by using a faster frequency sweeping signal source or a pulse generator. Thus, an ultrafast location detection allows sensing targets or objects in real time.

This disclosure uses microwave MTM-based materials. MTMs in general are artificially engineered materials exhibiting electromagnetic properties that cannot be found in nature, such as negative phase velocity and negative refractive index. Moreover, microwave MTMs-based leaky wave antennas have a unique space-to-frequency mapping characteristic, which, as discussed above, may be used to realize the ultrafast target detecting scheme. By simply mapping locations to frequencies, the disclosed target detecting method does not use post-processing algorithms of signals that are commonly used in conventional imaging or radar systems, or may use simple processing techniques to identify the main beam from which an azimuthal orientation of an object may be determined.

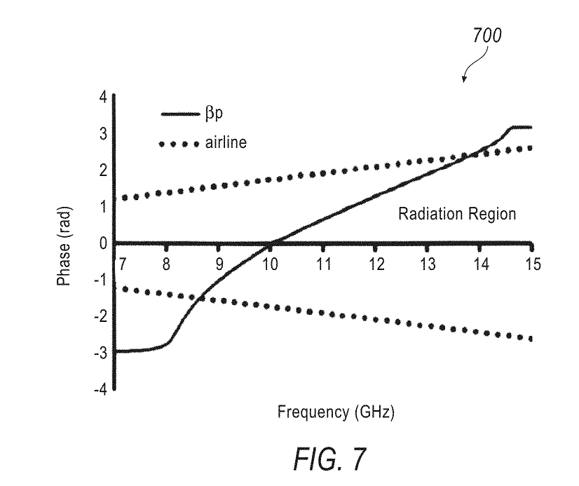

The frequency-space mapping of the CRLH LWAs can be visualized by dispersion diagram. FIG. 7 shows a dispersion diagram 700 of LWA used in the disclosed ultrafast location detecting scheme, in which β is the propagation constant and p is the unit cell periodicity. The frequency range where βp is in between the two air-lines is the fast wave region, in which the structure will radiate. As a result, the radiating region in this case is from 8.67-13.89 GHz with the center frequency of 10 GHz, which covers the X-band that is commonly used in radar systems. The direction of main beam (θ) of LWA as a function of frequency can be determined as follows:

$$θ ( ω ) = {sin}^{- 1} [ \frac{β ( ω )}{{k}_{0}} ] , \qquad Eqn . 2$$

in which k₀ is the free space wave number. This mapping of main beam direction θ is plotted in FIG. 3. The CRLH LWA is therefore able to perform a continuous beam scanning from −90° to +90° by sweeping the frequency, thereby mapping the full half-space of the antenna to different frequency components of the signal.

As such, disclosed also is a method for detecting a location of an object. The method includes emitting electromagnetic radiation from a microwave metamaterial leaky wave antenna over a field-of-view (FOV), such that its frequency continuously increases over the FOV as a function of an azimuthal direction, receiving the electromagnetic radiation that is reflected from an object that is positioned within the FOV, identifying a main beam frequency within the reflected radiation, and determining an azimuthal angle to the object based on the main beam frequency.

The disclosed method also includes generating a wideband signal in a signal source that includes a continuously variable frequency from a first frequency to a second frequency, inputting the wideband signal as an input to the microwave metamaterial leaky wave antenna, and mapping the input from the first frequency to the second frequency using the microwave metamaterial leaky wave antenna.

Disclosed also is a transceiver assembly for locating an object that includes a microwave metamaterial leaky wave antenna that receives a wideband signal from a source and as an input, the microwave metamaterial leaky wave antenna maps the wideband signal from a first frequency to a second frequency as electromagnetic radiation that increases as a function of an azimuthal direction, the microwave metamaterial leaky wave antenna positionable toward an object that is within its field-of-view (FOV), wherein the transceiver assembly is positioned to receive reflected electromagnetic radiation from the object, and an analyzer configured to identify a main beam frequency of the reflected electromagnetic radiation and determine an azimuthal angle to the object based on the main beam frequency.

The disclosure can not only be used in automotive radars for cars, but also can be used in other microwave imaging systems, such as microwave tomography for medical use as well as defense and military radar for real time detection. In one example, a microwave metamaterials-based ultrafast detecting scheme for automotive radars is disclosed. In addition, the disclosed system and method can be used for very sensitive measurements such as movement of a human due to breathing, and such as for measuring vehicle vibrations. In other words, although a more macroscopic arrangement of object detection is disclosed in the above figures and discussion, it is contemplated that, due to the very high rate of signal emission and data measurement, any measurements may be used that may benefit from the very fast determination of azimuthal direction of an object.

It is also contemplated that system 100, for instance, may be implemented by use of a computer or computing system. As such, referring back to FIG. 1, a computer or computer system 120 may be included as part of system 100 that may be used for providing instructions during operation of system 100, inputting operating parameters, or visualizing data. An implementation of system 100 in an example includes a plurality of components such as one or more of electronic components, hardware components, and/or computer software components. An exemplary component of an implementation of the system 100 employs and/or comprises a set and/or series of computer instructions written in or implemented with any of a number of programming languages, as will be appreciated by those skilled in the art.

An implementation of system 100 in an example employs one or more computer readable signal bearing media. A computer-readable signal-bearing medium in an example stores software, firmware and/or assembly language for performing one or more portions of one or more implementations. A computer-readable signal-bearing medium for an implementation of the system 100 in an example comprises one or more of a magnetic, electrical, optical, biological, and/or atomic data storage medium. For example, an implementation of the computer-readable signal-bearing medium comprises floppy disks, magnetic tapes, CD-ROMs, DVD-ROMs, hard disk drives, and/or electronic memory. In another example, an implementation of the computer-readable signal-bearing medium comprises a modulated carrier signal transmitted over a network comprising or coupled with an implementation of the system 100, for instance, an internal network, the Internet, a wireless network, and the like.

A technical contribution for the disclosed method and apparatus is that it provides for a computer-implemented apparatus and method of providing driving assistance in a vehicle to detect azimuthal locations of objects over a wide angle and range.

When introducing elements of various aspects of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the disclosed materials have been described in detail in connection with only a limited number of examples, it should be readily understood that the disclosure is not limited to such disclosed examples. Rather, that disclosed can be modified to incorporate any number of variations, alterations, substitutions or equivalent arrangements not heretofore described, but which are commensurate with the spirit and scope of the disclosed materials. Additionally, while various examples have been described, it is to be understood that disclosed aspects may include only some of the described examples. Accordingly, that disclosed is not to be seen as limited by the foregoing description, but is only limited by the scope of the appended claims.

What is claimed is:

1. A system for locating an object, comprising:
a signal source that generates a wideband signal that includes a continuously variable frequency from a first frequency to a second frequency;
a microwave metamaterial leaky wave antenna that receives the wideband signal as an input and maps the wideband signal from the first frequency to the second frequency as electromagnetic radiation that increases as a function of an azimuthal direction, the microwave metamaterial leaky wave antenna positionable to face toward an object that is within its field-of-view (FOV), wherein the transceiver assembly is positioned to receive the electromagnetic radiation that is reflected from the object and convert the reflected electromagnetic radiation to a reflected electrical signal; and
an analyzer configured to identify a main beam frequency of the reflected electrical signal and determine an azimuthal angle to the object based on the main beam frequency.

2. The system of claim 1, wherein the FOV extends as a full FOV from −90 degrees to +90 degrees and the microwave metamaterial leaky wave antenna maps the wideband signal over the full FOV.

3. The system of claim 1, wherein the wideband signal is output as a pulse signal from the first frequency to the second frequency, the reflected electromagnetic radiation is detected by the microwave metamaterial leaky wave antenna between pulses, and the analyzer is coupled to the microwave metamaterial leaky wave antenna.

4. The system of claim 1, wherein the wideband signal is output as a linearly chirped signal that sweeps from the first frequency to the second frequency.

5. The system of claim 4, wherein the system further comprises a separate antenna positioned proximate the microwave metamaterial leaky wave antenna that receives the reflected electromagnetic radiation.

6. The system of claim 5, wherein the antenna is a horn antenna.

7. The system of claim 1, wherein the microwave metamaterial leaky wave antenna is a composite right/left-handed transmission line (CRLH TL).

8. The system of claim 1, wherein the main beam frequency is identified as approximately a maximum frequency of the reflected electromagnetic radiation.

9. A method for detecting a location of an object, the method comprising:
emitting electromagnetic radiation from a microwave metamaterial leaky wave antenna over a field-of-view (FOV), such that its frequency continuously increases over the FOV as a function of an azimuthal direction;
receiving the electromagnetic radiation that is reflected from an object that is positioned within the FOV;
identifying a main beam frequency within the reflected radiation; and
determining an azimuthal angle to the object based on the main beam frequency.

10. The method of claim 9, further comprising:
generating a wideband signal in a signal source that includes a continuously variable frequency from a first frequency to a second frequency;
inputting the wideband signal as an input to the microwave metamaterial leaky wave antenna; and
mapping the input from the first frequency to the second frequency using the microwave metamaterial leaky wave antenna.

11. The method of claim 9, wherein receiving the reflected electromagnetic radiation further comprises receiving the electromagnetic radiation that is reflected in the microwave metamaterial leaky wave antenna.

12. The method of claim 11, wherein emitting the electromagnetic radiation comprises emitting the electromagnetic radiation as a pulse signal, and receiving the reflected electromagnetic radiation occurs between pulses of the pulse signal.

13. The method of claim 9, wherein receiving the reflected electromagnetic radiation further comprises receiving the electromagnetic radiation that is reflected in a separate antenna that is positioned proximate the microwave metamaterial leaky wave antenna.

14. The method of claim 9, wherein the separate antenna is a horn antenna.

15. The method of claim 9, wherein the microwave metamaterial leaky wave antenna is a composite right/left-handed transmission line (CRLH TL).

16. The method of claim 9, wherein determining the azimuthal angle to the object further comprises identifying the main beam frequency as approximately a maximum frequency of the reflected electromagnetic radiation.

17. A transceiver assembly for locating an object, the assembly comprising:
a microwave metamaterial leaky wave antenna that receives a wideband signal from a source and as an input, the microwave metamaterial leaky wave antenna maps the wideband signal from a first frequency to a second frequency as electromagnetic radiation that increases as a function of an azimuthal direction, the microwave metamaterial leaky wave antenna positionable toward an object that is within its field-of-view (FOV), wherein the transceiver assembly is positioned to receive reflected electromagnetic radiation from the object; and
an analyzer configured to identify a main beam frequency of the reflected electromagnetic radiation and determine an azimuthal angle to the object based on the main beam frequency.

18. The assembly of claim 17, wherein the FOV extends as a full FOV from −90 degrees to +90 degrees and the microwave metamaterial leaky wave antenna maps the wideband signal over the full FOV from the first frequency to the second frequency.

19. The assembly of claim 17, wherein the wideband signal is output as one of:
a pulse signal from the first frequency to the second frequency, wherein the reflected electromagnetic radiation is detected by the microwave metamaterial leaky wave antenna between pulses; and
a linearly chirped signal that sweeps from the first frequency to the second frequency, wherein the transceiver assembly further comprises a separate antenna positioned proximate the microwave metamaterial leaky wave antenna that receives the electromagnetic radiation that is reflected from the object.

20. The assembly of claim 17, wherein the main beam frequency is identified as approximately a maximum frequency of the reflected electromagnetic radiation.
